(19) United States
(12) Patent Application Publication
(10) Pub. No.: US 2026/0346406 A1
(43) Pub. Date: Nov. 5, 2026

(54) ADJUSTABLE WRENCH

(71) Applicant: PROXENE TOOLS CO., LTD., Taichung City (TW)

(72) Inventors: Chang-Ming WU, Taichung City (TW); Arthur WU, Taichung City (TW)

(21) Appl. No.: 19/194,254

(22) Filed: Apr. 30, 2025

(51) Int. Cl. B25B 13/14

(52) U.S. Cl. CPC B25B 13/14

(57) ABSTRACT

An adjustable wrench is provided, wherein the adjustable wrench includes: a main body including a handle and a working head connected to the handle, the working head including a fixed jaw and a movable jaw; and a worm shaft rotatably mounted on the main body and engaged with the movable jaw, the worm shaft including an axial direction, a circumferential surface around the axial direction, and a plurality of threads alternately arranged in the axial direction and extending on the circumferential surface around the axial direction in a spiral direction, each of the plurality of threads including a side surface, at least one of two end portions of at least one of the plurality of threads including an inclined guide surface, the inclined guide surface being transitionally connected to the side surface relative to the spiral direction.

### BACKGROUND OF THE INVENTION

### Field of the Invention

The present invention relates to a driving tool, particularly to an adjustable wrench.

### Description of the Prior Art

Adjustable wrench has an adjustable opening size and is applicable to fastening elements of various sizes. Therefore, it is commonly used in the fields of assembly, joining, and fastening of devices. A general adjustable wrench includes a fixed jaw, a movable jaw that is movably adjusted relative to the fixed jaw, and a worm shaft engaged with a toothed row of the movable jaw. By rotating the worm shaft, the movable jaw can be driven to move toward or away from the fixed jaw, thereby adjusting the opening size of the adjustable wrench.

However, in the conventional worm shaft, the ends of the plurality of threads extend along the same direction as the spiral direction of the thread. This results in sharpened terminal edges at the truncated ends of the plurality of threads, which not only hinder smooth guidance into the toothed row engaged with the movable jaw but also increase the risk of pricking or cutting the user's hand during operation.

The present invention is, therefore, arisen to obviate or at least mitigate the above-mentioned disadvantages.

### SUMMARY OF THE INVENTION

The main object of the present invention is to provide an adjustable wrench, in which a worm shaft can be smoothly and effectively guided into a toothed row of a movable jaw of the adjustable wrench and can prevent hand pricks or cuts during operation.

To achieve the above and other objects, an adjustable wrench is provided, wherein the adjustable wrench includes: a main body including a handle and a working head connected to the handle, the working head including a fixed jaw and a movable jaw; and a worm shaft rotatably mounted on the main body and engaged with the movable jaw, the worm shaft including an axial direction, a circumferential surface around the axial direction, and a plurality of threads alternately arranged in the axial direction and extending on the circumferential surface around the axial direction in a spiral direction, each of the plurality of threads including a side surface, at least one of two end portions of at least one of the plurality of threads including an inclined guide surface, the inclined guide surface being transitionally connected to the side surface relative to the spiral direction.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an adjustable wrench of an exemplary embodiment of the present invention;

FIG. 2 is an enlarged partial view of FIG. 1;

FIG. 3 is a perspective view of a worm shaft of an exemplary embodiment of the present invention;

FIG. 4 is another perspective view of the worm shaft of an exemplary embodiment of the present invention;

FIG. 5 is a radial side view of the worm shaft of an exemplary embodiment of the present invention;

FIG. 6 is a right side view of FIG. 3;

FIG. 7 is a left side view of FIG. 4; and

FIG. 8 is yet another perspective view of the worm shaft of an exemplary embodiment of the present invention.

### DETAILED DESCRIPTION OF THE PREFERRED EMBODIMENTS

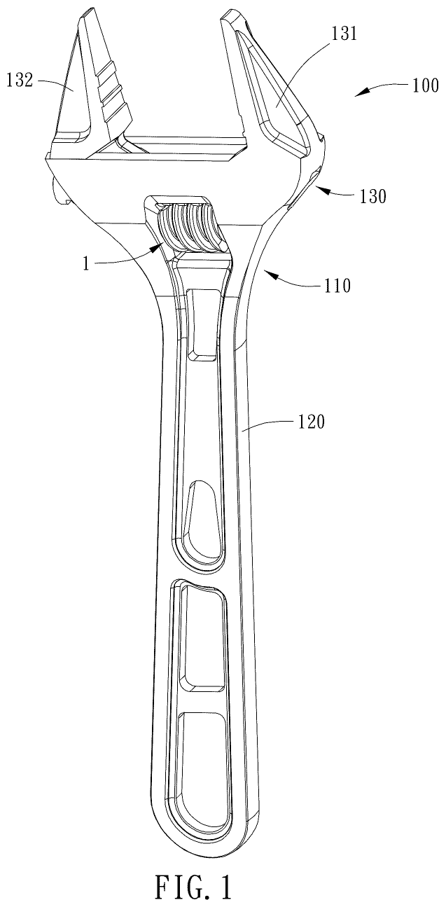

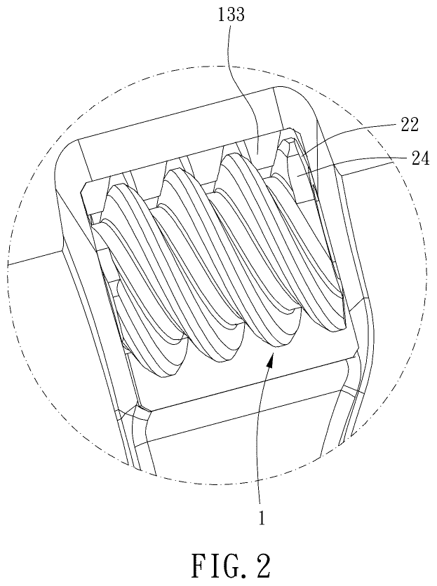

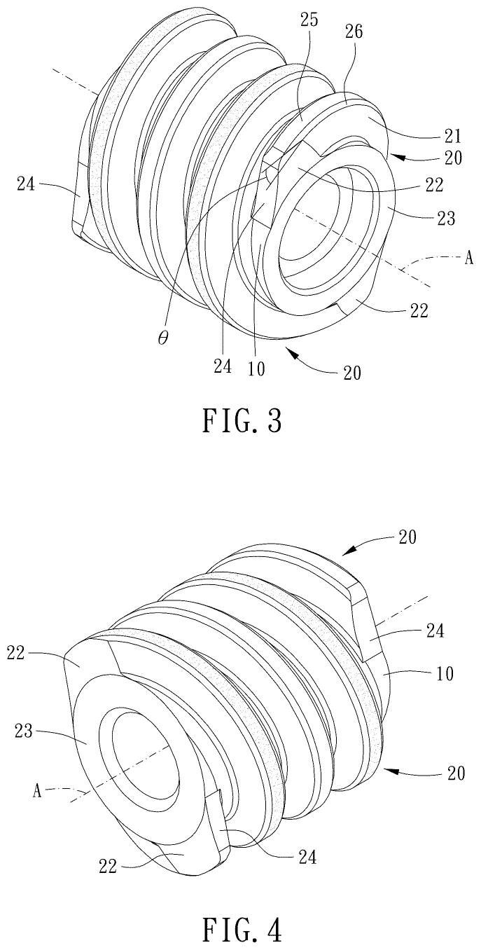

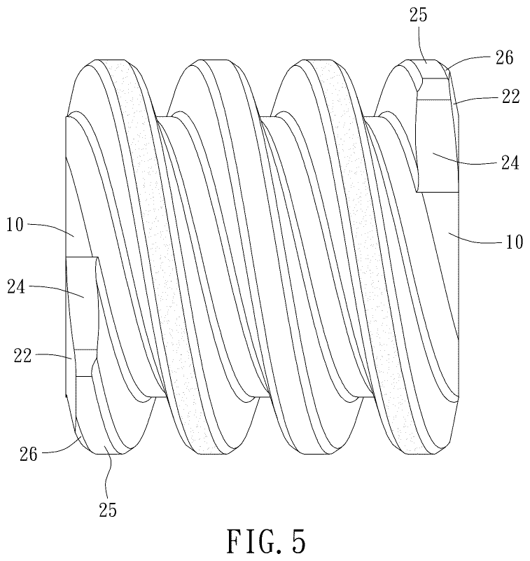

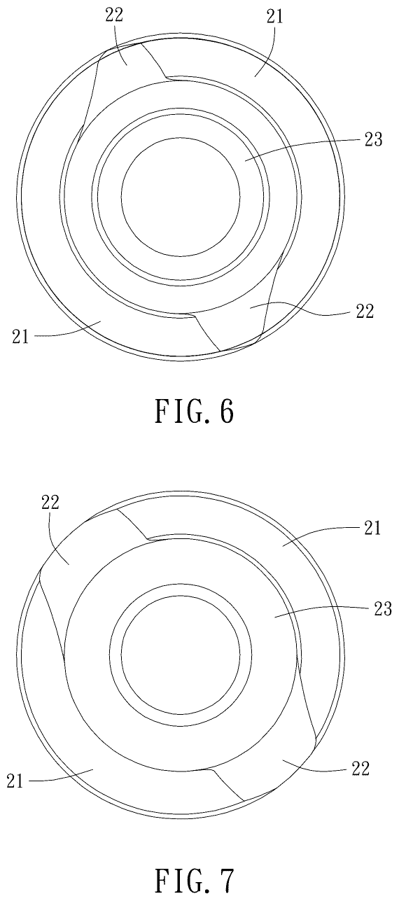

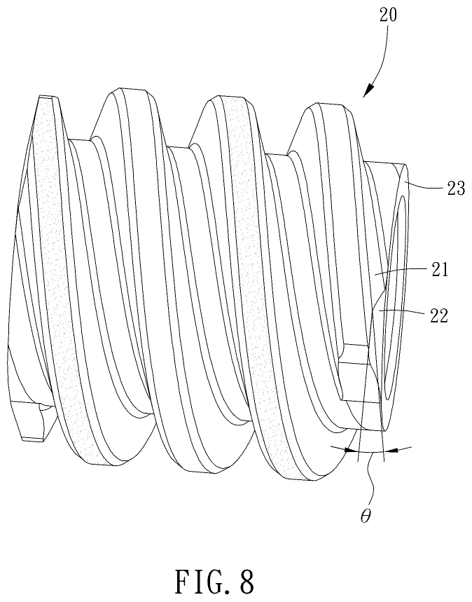

Please refer to FIGS. 1 to 8 for an exemplary embodiment of the present invention. An adjustable wrench 100 of the present invention includes a main body 110 and a worm shaft 1.

The main body 110 includes a handle 120 and a working head 130 connected to the handle 120. The working head 130 includes a fixed jaw 131 and a movable jaw 132. The worm shaft 1 is rotatably mounted on the main body 110 and is engaged with the movable jaw 132. The worm shaft 1 includes an axial direction A, a circumferential surface 10 around the axial direction A, and a plurality of threads 20. The plurality of threads 20 are alternately arranged in the axial direction A and extend on the circumferential surface 10 around the axial direction A in a spiral direction. Each of the plurality of threads 20 includes a side surface 21. At least one of two end portions of at least one of the plurality of threads 20 includes an inclined guide surface 22. In the spiral direction, the inclined guide surface 22 is transitionally connected to the side surface 21. Accordingly, when adjusting the movable jaw 132 of the adjustable wrench 100, the inclined guide surface 22 can be smoothly and reliably guided into the toothed row 133 of the movable jaw 132, preventing hand pricks or cuts during operation.

In this embodiment, ends of the plurality of threads 20 are equiangularly arranged relative to the axial direction A; however, non-equiangular arrangements are also feasible. Specifically, the worm shaft 1 of the adjustable wrench 100 includes two threads 20 arranged oppositely in the radial direction. The worm shaft 1 may also include other quantities of threads, such as three, four, or more. The transitional angle θ from the side surface 21 to the inclined guide surface 22 in the direction away from the axial end face is from 3 degrees to 35 degrees. For example, depending on different sizes, torque requirements, or radial dimensions of the worm shaft, the transitional angle θ such as 5°, 8°, 11°, 14°, 17°, 20°, 23°, 30° or 33°, or any angle in between may be designed.

In this embodiment, the inclined guide surface 22 is further connected to the circumferential surface 10, thus providing a wide guiding area. The inclined guide surface 22 is also further connected to an axial end face 23 of the worm shaft 1, allowing a greater thread length within a smaller overall length and providing a flat end face to facilitate rotation of the worm shaft 1 and reinforce the structural strength at its end. It is understood that the inclined guide surface 22 may also be spaced from the axial end face 23 of the worm shaft 1. Specifically, the inclined guide surface 22 extends obliquely from the axial end face 23 radially outward and in a direction away from the axial end face 23. Even within a certain margin of error, it can still be smoothly guided into the toothed row 133 of the movable jaw 132.

Specifically, each of the plurality of threads 20 further includes an end inclined surface 24 which is transversely connected to the circumferential surface 10 and transversely connected to the inclined guide surface 22. Each of the plurality of threads 20 further includes a top surface 25 and a chamfer surface 26. The chamfer surface 26 is obliquely connected to and between the side surface 21 and the top surface 25. The inclined guide surface 22 is further connected to the end inclined surface 24 and the chamfer surface 26. The inclined guide surface 22 may also be further connected to the chamfer surface 26 only. For example, the inclined guide surface 22 at one end portion of the thread 20 is connected to the end inclined surface 24 and the chamfer surface 26, while the inclined guide surface 22 at the other end portion of the thread 20 is connected to the end inclined surface 24, the chamfer surface 26, and the top surface 25. This configuration allows smoother guidance into the toothed row 133 of the movable jaw 132. The end inclined surface 24 may be concave, convex, or flat. Preferably, the width of the end inclined surface 24 is greater than the width of the top surface 25, thereby increasing the surface area to facilitate pushing of the worm shaft 1 and effectively preventing pricks or cuts during operation.

Preferably, each of the plurality of threads 20 includes the inclined guide surface 22, and both end portions of at least one of the plurality of threads 20 include the inclined guide surface 22. In this embodiment, relative to the circumferential surface 10, the inclination angle of the inclined guide surface 22 is greater than that of the side surface 21, and the difference between the inclination angle of the inclined guide surface 22 and the inclination angle of the circumferential surface is not less than 5 degrees. Both end portions of each of the plurality of threads 20 include the inclined guide surface 22, so during forward and reverse operation of the worm shaft 1, smooth guidance into the toothed row 133 of the movable jaw 132 is ensured, and pricks or cuts during operation are effectively prevented.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An adjustable wrench including:
a main body including a handle and a working head connected to the handle, the working head including a fixed jaw and a movable jaw; and
a worm shaft rotatably mounted on the main body and engaged with the movable jaw, the worm shaft including an axial direction, a circumferential surface around the axial direction, and a plurality of threads alternately arranged in the axial direction and extending on the circumferential surface around the axial direction in a spiral direction, each of the plurality of threads including a side surface, at least one of two end portions of at least one of the plurality of threads including an inclined guide surface, the inclined guide surface being transitionally connected to the side surface relative to the spiral direction.

2. The adjustable wrench of claim 1, wherein the inclined guide surface is further connected to the circumferential surface.

3. The adjustable wrench of claim 1, wherein the inclined guide surface is further connected to an axial end face of the worm shaft.

4. The adjustable wrench of claim 3, wherein the inclined guide surface extends obliquely from the axial end face radially outward and in a direction away from the axial end face.

5. The adjustable wrench of claim 1, wherein each of the plurality of threads further includes an end inclined surface, and the end inclined surface is transversely connected to the circumferential surface and transversely connected to the inclined guide surface.

6. The adjustable wrench of claim 5, wherein each of the plurality of threads further includes a top surface and a chamfer surface, the chamfer surface is obliquely connected to and between the side surface and the top surface, and the inclined guide surface is further connected to the end inclined surface and the chamfer surface.

7. The adjustable wrench of claim 1, wherein each of the plurality of threads further includes a top surface and a chamfer surface, the chamfer surface is obliquely connected to and between the side surface and the top surface, and the inclined guide surface is further connected to the chamfer surface.

8. The adjustable wrench of claim 1, wherein each of the plurality of threads includes the inclined guide surface.

9. The adjustable wrench of claim 6, wherein ends of the plurality of threads are equiangularly arranged relative to the axial direction; each of the plurality of threads includes the inclined guide surface; at least one of the plurality of threads includes the inclined guide surface at each of the two end portions; the inclined guide surface is further connected to the circumferential surface; the inclined guide surface is further connected to an axial end face of the worm shaft; the inclined guide surface extends obliquely from the axial end face radially outward and in a direction away from the axial end face; each of the plurality of threads further includes a top surface and a chamfer surface, the chamfer surface is obliquely connected between the side surface and the top surface, the inclined guide surface at one end portion of the thread is connected to the end inclined surface and the chamfer surface, and the inclined guide surface at another end portion of the thread is connected to the end inclined surface, the chamfer surface and the top surface; the width of the end inclined surface is greater than the width of the top surface; relative to the circumferential surface, an inclination angle of the inclined guide surface is greater than an inclination angle of the side surface; and a difference between the inclination angle of the inclined guide surface and the inclination angle of the circumferential surface is not less than 5 degrees.

10. The adjustable wrench of claim 3, wherein a transitional angle from the side surface to the inclined guide surface in the direction away from the axial end face is from 3 degrees to 35 degrees.
